(19) United States
(12) Patent Application Publication
(10) Pub. No.: US 2010/0186194 A1
(43) Pub. Date: Jul. 29, 2010

(54) HOLDING ELEMENT FOR HOLDING AN ASSEMBLY IN A HOLDER, AND FASTENING ARRANGEMENT

(76) Inventors: Radek Malec, Ceske Budejovice (CZ); Vladimir Ptacek, Modrany (CZ); Martin Ptacek, Ceske Budejovice (CZ); Martin Sykora, Ceske Budejovice (CZ); Josef Jarosik, Ceske Budejovice (CZ); Miloslav Gabris, Ceske Budejovice (CZ)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/663,642

(22) PCT Filed: Apr. 11, 2008
(86) PCT No.: PCT/EP2008/054437

§ 371 Date: Dec. 8, 2009

(30) Foreign Application Priority Data
Jun. 8, 2007 (DE) 102007026670.9

(51) Int. Cl. A44B 99/00; F16B 45/00

(52) U.S. Cl. 24/1; 24/698.1

(57) ABSTRACT

Holding elements are known for holding an assembly in a holder, comprising a holding section for engaging behind the assembly and holding members that are provided on the holding section for holding the assembly in the holder. It is disadvantageous that the holding element is comparatively expensive to produce. For example, it is configured very rigidly in the holding direction, which is achieved with a comparatively high amount of material. This results in high production costs. In addition, in the case of very high mechanical loads the detent connection can detach due to torque acting on the detent hooks. The holding element according to the invention is simplified, thereby lowering the production costs. According to the invention, the holding section has a flat configuration viewed in the holding direction, and the holding members are angled in relation to the holding section and configured as elastically resilient holding arms.

### PRIOR ART

The invention is based on a holding element for holding an assembly in a holder as generically defined by the preamble to claim 1 and on a fastening arrangement as defined by claim 10. A holding element for holding a pressure regulator in a holder is already known from German Patent Disclosure DE 197 24 165 A1 and has a holding portion for engaging the assembly from behind and has holding means, provided on the holding portion, for holding the assembly in the holder. The mounting of the holding element is comparatively complicated, since to secure the detent connection, a securing tab is provided that has to be folded over in an additional work step upon mounting.

### ADVANTAGES OF THE INVENTION

The holding element of the invention having the definitive characteristics of claim 1 has the advantage over the prior art that the complexity of mounting for the holding element is reduced, since because of the self-locking design, no additional provisions for securing the detent connection are necessary. This is attained by providing that the holding portion is embodied as flat, viewed in the holding direction, and that the holding means are angled relative to the holding portion and embodied as a spring arm. In this way, the holding portion has a large contact area with the assembly, so that the pressure per unit of surface area is reduced, and the durability of the connection is improved.

The holding element can be produced easily, since a single stamping operation and only a few bending operations suffice in the production process.

By the provisions recited in the dependent claims, advantageous refinements of and improvements to the holding element defused by the main claim are possible.

It is especially advantageous if the detent tongue is positioned obliquely relative to the legs in such a way that in the installed with tension relief acting the legs, it is bent inward relative to the through opening. In this way, a self-locking detent connection is attained, whose detent tongue moves farther toward the detent hook on being mechanically loaded, so that the detent connection remains reliably closed even under very heavy mechanical loads.

It is also advantageous if the detent tongue is embodied as curved or rounded on its free end, since the free end of the detent tongue is more easily movable in this way.

It is very advantageous if contact means for electrically contacting the assembly are embodied on the annular portion of the holding element, since in this way electrical charges can flow away from the assembly to the holding element, and electrical grounding of the assembly can be attained.

It is also advantageous if the contact means are angled relative to the annular portion and extend in the opposite direction from the holding means, since in this way the contact means are embodied as elastically resilient, so that secure electrical contacting is attained.

In an advantageous feature, the contact means are embodied in tonguelike or striplike form.

It is also advantageous if the holding means are disposed diametrically opposite on the annular portion, since in this way the detent connection can absorb the maximum holding forces.

It is furthermore advantageous if the holding element is made from flat material, and the holding means are integrally formed onto the outside, remote from the through opening, and/or the contact means are integrally formed onto the inside, oriented toward the through opening. The holding element is stamped out from sheet metal in one piece with the holding means and contact means.

It is advantageous if an electrical terminal for connecting an electrical conductor is provided, since the electrical discharges can in this way be dissipated from the holding element to an electrical ground.

### DRAWINGS

One exemplary embodiment of the invention is shown in simplified form in the drawings and explained in further detail in the ensuing description.

FIG. 1 in section shows an assembly that is held in a holder by means of a holding element according to the invention;

FIG. 2 is a side view of the holding element of the invention;

FIG. 3 is a top view on the holding element of the invention;

FIG. 4 is a further side view of the holding element of the invention; and

FIG. 5 shows a detail of the holding element of the invention in FIG. 4.

### DESCRIPTION OF THE EXEMPLARY EMBODIMENT

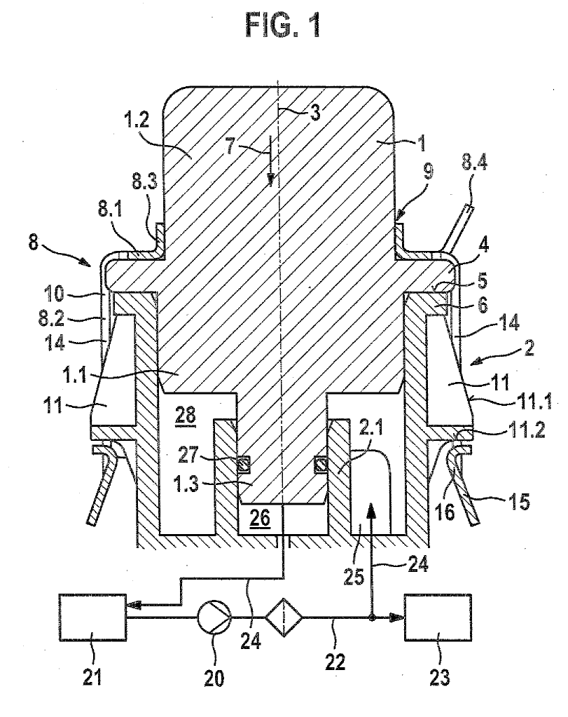

FIG. 1 in section shows an assembly that is held in a holder by means of a holding element according to the invention.

The assembly 1 is inserted with a first housing portion 1.1 into a holder 2 and is held there in the radial direction relative to a longitudinal axis 3 of the assembly 1. The holder 2 is for instance embodied in bushlike form, and the assembly 1 can be inserted with a precise fit into the holder 2. However, the holder 2 could also comprise a plurality of separate holders.

The axial position of the assembly 1 in the holder 2 is determined by a stop 4, which may be provided on either the assembly 1 or the holder 2. The stop 4 determines the depth to which the first housing portion 1.1 plunges into the holder 2. In the exemplary embodiment, the stop 4 is disposed on the assembly 1 and embodied as a shoulder, which for instance extends annularly all the way around the circumference. The assembly 1 is inserted into the holder 2 with the housing portion 1.1 that extends as far as the shoulder 4 and rests with its shoulder 4 on a face end 5 of the holder 2. A shoulderlike flange 6, for instance, is provided on the face end 5 of the holder 2.

The assembly 1 is secured in the holder 2 by means of a holding element 8, so that loosening out of the holder 2 is prevented. The holding element 8 holds the assembly 1 down against the holder 2 in a holding direction 7 in that it engages the assembly 1 from behind with a holding portion 8.1 and is fixed or anchored on the outside of the holder 2 by means of at least two holding means 8.2.

The holding portion 8.1 is embodied annularly or in caplike fashion, for instance, and surrounds a through opening 9, through which the assembly 1 protrudes with a second housing portion 1.2. The shoulder 4 is provided between the first housing portion 1.1 and the second housing portion 1.2. The holding element 8 rests with its holding portion 8.1 on the shoulder 4 of the assembly 1, for example.

According to the invention, viewed in the holding direction 7, the holding portion 8.1 is embodied as flat. This means that the height H of the holding portion 8.1 is substantially less than the width B1 of the annular holding portion 8.1. In this way, a large contact area on the assembly 1 is attained, which reduces the pressure per unit of surface area on the assembly 1.

The holding means 8.2 are also angled relative to the holding portion 8.1 and embodied as elastically resilient holding arms. These anus are essentially subjected to tensile stress. The holding arms 8.2 are integrally formed onto the outside, remote from the through opening 9, of the holding portion 8.1 and extend essentially in the axial direction relative to the longitudinal axis 3.

Each of the holding arms 8.2 has a recess 10 that can be locked to a respective detent hook 11 of the holder 2, forming a detent connection. The detent hook 11 is disposed on the outside of the holder 2 and is fowled by a ramp 11.1, which rises in the axial direction remote from the flange 6, and forms a steplike undercut 11.2.

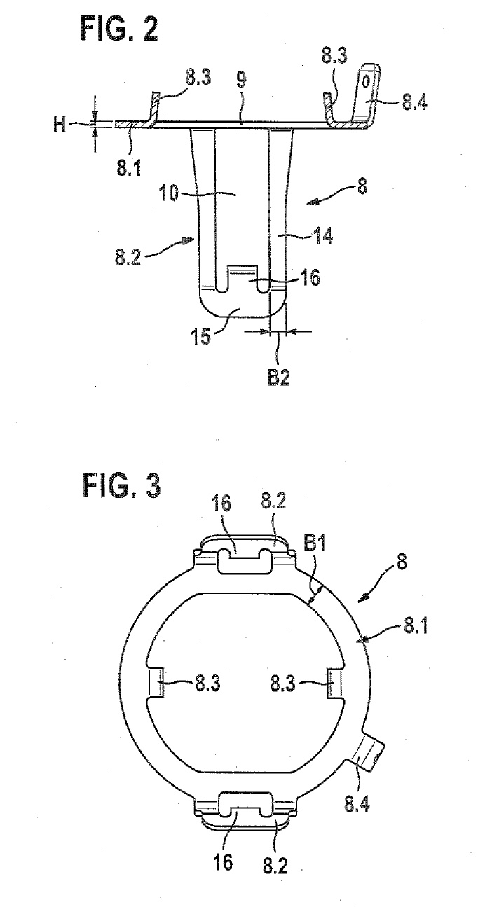

Upon mounting, the holding arm 8.2 snaps elastically with its recess 10 into the detent hook 11, whereupon the crosspiece 15 engages the undercut 11.2 from behind. Because of the recess 10, the holding arms 8.2 have the shape of a “U”, each with two legs 14 and one crosspiece or bow 15 (FIG. 2) joining the legs 14.

In the exemplary embodiment, a detent tongue 16 is integrally formed onto the crosspiece 15 and is positioned obliquely at an angle 17 relative to the legs 14 in such a way that in the installed state, with tension relief acting on the legs 14, it is bent with its free end elastically inward relative to the longitudinal axis 3. This prevents the holding arm 8.2 from coming unlatched from the detent hook 11 in response to a torque acting outward when a mechanical load is put on the holding arm 8.2. In this way, the detent connection is embodied as self-locking. The detent tongue is positioned obliquely relative to the legs 14 or to the longitudinal axis 3 by approximately 20 to 30°, for instance.

If an axial load is exerted on the assembly 1 in the direction facing away from the holder 2, the crosspiece 15 is braced, for instance by the detent tongue 16, on the undercut 11.2 of the detent hook 11 and because of the oblique disposition is bent elastically radially inward relative to the longitudinal axis 3.

On its free end, the detent tongue 16 is embodied as bent or rounded, so that the free end of the detent tongue 16 is more easily movable in the radial direction.

Besides its holding function, the holding element 8 for instance also has the function of grounding the assembly 1 electrically, or in other words of diverting electrical charges from the assembly 1 to an electrical ground. For that purpose, at least one contact means 8.3 for electrically contacting the assembly 1 is embodied on the holding portion 8.1. The contact means 8.3 are disposed on the inside of the holding portion 8.1, the side oriented toward the through opening 9, and are angled relative to the holding portion 8.1. For instance, they are positioned obliquely to the assembly 1. They extend in the opposite direction from the holding anus 8.2, or in other words in the direction facing away from the holder 2. The contact means 8.3 are embodied in tonguelike, luglike or striplike fashion, for instance. The free ends of the contact means 8.3 are pressed elastically resiliently against the second housing portion 1.2, thus ensuring the electrical contacting of the assembly 1.

The holding element 8 comprises stamped or bent sheet-metal material, such as spring steel, and the holding portion 8.1 of the holding element 8 rests over a large area, that is, with its flat side, on the shoulder 4 of the assembly 1. The holding element 8 is embodied in one piece. The holding arms 8.2 and the contact means 8.3 are accordingly formed integrally in one piece on the holding portion 8.1.

An electrical terminal 8.4 for connecting an electrical conductor is also provided on the holding element 8, in order to dissipate the electrical charges to the electrical ground. The electrical terminal 8.4 is embodied for instance as a connection lug and is integrally formed on the outside of the holding portion 8.1.

The assembly 1 in the exemplary embodiment is a pressure regulator of a fuel delivery device, but it may be any arbitrary other assembly. The fuel delivery device has a delivery unit 20, which delivers fuel, at elevated pressure, from a fuel tank 21 to an internal combustion engine 23 via a pressure line 22. From the pressure line 22, a return line 24 branches off that discharges into an inlet 25 to the holder 2. The pressure regulator opens beyond a predetermined pressure in the inlet 25 and allows fuel to flow back into the fuel tank 21 via an outlet 26 of the holder 2. The pressure regulator is for instance a known diaphragm pressure regulator, which has a diaphragm body that cooperates with a valve seat.

Together with the pressure regulator inserted into the holder 2, the holder encloses an inner chamber 28, into which the inlet 25 discharges. The outlet 26 is embodied in stublike fashion, for instance, and protrudes into the inner chamber 28. The fluidic communication from the inlet 25 to the outlet 26 of the holder 2 is controlled by the pressure regulator.

With an outlet stub 1.3, the pressure regulator protrudes with a precise fit into the outlet 26 of the holder 2. A sealing means 27, which seals off the connection, is provided on the outlet stub 1.3.

As a result of the hydraulic pressure of the pressure line 22, a force acts on the pressure regulator in an axial direction facing away from the holder 2, and this force seeks to force the pressure regulator out of the holder 2. The holding element 8 acts counter to this force and securely holds the pressure regulator in the holder 2.

Upon mounting, the assembly 1 is inserted into the holder 2. Next, the holding element 8 is slipped onto the assembly 1, and the holding arms 8.2 are locked resiliently to the detent hooks 11.

FIG. 2 in section is a side view of the holding element of the invention.

In the holding element of FIG. 2, the parts that remain the same or function the same as in the view in FIG. 1 are identified by the same reference numerals.

The width B2 of the legs 14 for instance increases toward the holding portion 8.1.

FIG. 3 is a top view on the holding element of the invention.

In the holding element of FIG. 3, the parts that remain the same or function the same as in the view in FIGS. 1 and 2 are identified by the same reference numerals.

The holding arms 8.2 are disposed diametrically opposite on the holding portion 8.1. Two contact means 8.3 are for instance provided for electrically contacting the assembly 1, but more or fewer than two contact means 8.3 may also be provided.

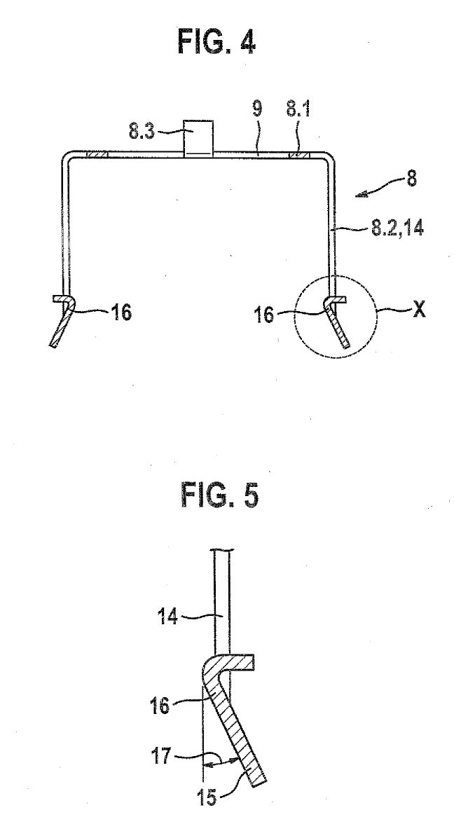

FIG. 4 is a further side view of the holding element of the invention.

In the holding element of FIG. 4, the parts that remain the same or function the same as in the view in FIGS. 1 through 3 are identified by the same reference numerals.

FIG. 5 shows a detail X of the holding element of the invention in FIG. 4.

In the holding element of FIG. 5, the parts that remain the same or function the same as in the view in FIGS. 1 through 4 are identified by the same reference numerals.

1-10. (canceled)

11. A holding element for holding an assembly in a holder, comprising:
a holding portion for engaging the assembly from a rear side of the assembly, the holding portion being embodied as flat viewed in a holding direction; and
holding means provided on the holding portion for holding the assembly in the holder, the holding means being angled relative to the holding portion and being embodied as elastically resilient holding arms.

12. The holding element as defined by claim 11, wherein the holding means each have at least two legs and a crosspiece joining the legs, and a detent tongue is embodied on the crosspiece, which tongue is positioned obliquely relative to the legs such that in an installed state, with tension relief acting on the legs, the tongue is bent toward the holder.

13. The holding element as defined by claim 12, wherein the detent tongue is embodied as bent or rounded on its free end.

14. The holding element as defined by claim 11, wherein the holding portion is embodied annularly and has a through opening.

15. The holding element as defined by claim 14, wherein the holding means are disposed on an outside of the holding portion.

16. The holding element as defined by claim 14, wherein on an inside of the holding portion, contact means for electrically contacting the assembly are provided, which are angled relative to the holding portion.

17. The holding element as defined by claim 15, wherein on an inside of the holding portion, contact means for electrically contacting the assembly are provided, which are angled relative to the holding portion.

18. The holding element as defined by claim 1, wherein the holding means in the form of two holding arms are disposed diametrically opposite from one another on the holding portion.

19. The holding element as defined by claim 1, wherein the holding element is made from flat material.

20. The holding element as defined by claim 1, wherein an electrical terminal is provided for connecting an electrical conductor.

21. A fastening arrangement, comprising:
an assembly that is disposed in a holder which has detent hooks with undercuts, and
a holding element as defined by claim 11, holding the assembly in the holder, wherein the holding element is fastened with its holding arms on the detent hooks of the holder.

22. A fastening arrangement, comprising:
an assembly that is disposed in a holder which has detent hooks with undercuts, and
a holding element as defined by claim 12, holding the assembly in the holder, wherein the holding element is fastened with its holding arms on the detent hooks of the holder.

23. A fastening arrangement, comprising:
an assembly that is disposed in a holder which has detent hooks with undercuts, and
a holding element as defined by claim 13, holding the assembly in the holder, wherein the holding element is fastened with its holding arms on the detent hooks of the holder.

24. A fastening arrangement, comprising:
an assembly that is disposed in a holder which has detent hooks with undercuts, and
a holding element as defined by claim 14, holding the assembly in the holder, wherein the holding element is fastened with its holding arms on the detent hooks of the holder.

25. A fastening arrangement, comprising:
an assembly that is disposed in a holder which has detent hooks with undercuts, and
a holding element as defined by claim 15, holding the assembly in the holder, wherein the holding element is fastened with its holding arms on the detent hooks of the holder.

26. A fastening arrangement, comprising:
an assembly that is disposed in a holder which has detent hooks with undercuts, and
a holding element as defined by claim 16, holding the assembly in the holder, wherein the holding element is fastened with its holding arms on the detent hooks of the holder.

27. A fastening arrangement, comprising:
an assembly that is disposed in a holder which has detent hooks with undercuts, and
a holding element as defined by claim 17, holding the assembly in the holder, wherein the holding element is fastened with its holding arms on the detent hooks of the holder.

28. A fastening arrangement, comprising:
an assembly that is disposed in a holder which has detent hooks with undercuts, and
a holding element as defined by claim 18, holding the assembly in the holder, wherein the holding element is fastened with its holding arms on the detent hooks of the holder.

29. A fastening arrangement, comprising:
an assembly that is disposed in a holder which has detent hooks with undercuts, and
a holding element as defined by claim 19, holding the assembly in the holder, wherein the holding element is fastened with its holding arms on the detent hooks of the holder.

30. A fastening arrangement, comprising:
an assembly that is disposed in a holder which has detent hooks with undercuts, and
a holding element as defined by claim 20, holding the assembly in the holder, wherein the holding element is fastened with its holding arms on the detent hooks of the holder.
